(19) United States
(12) Patent Application Publication
(10) Pub. No.: US 2006/0155629 A1
(43) Pub. Date: Jul. 13, 2006

(54) Investment structure

(76) Inventor: Sundar Srinivasan, New York, NY (US)

Correspondence Address: RAYMOND R. MOSER JR., ESQ.;MOSER IP LAW GROUP, 1040 BROAD STREET, 2ND FLOOR, SHREWSBURY, NJ, 07702, US

(21) Appl. No.: 11/327,044

(22) Filed: Jan. 6, 2006

Related U.S. Application Data
(60) Provisional application No. 60/642,282, filed on Jan. 7, 2005.

(51) Int. Cl. G06Q 40/00

(52) U.S. Cl. 705/35

(57) ABSTRACT

Embodiments of an investment structure that avoids the earnings and ownership dilution related to an acquisition of a target company by a subsidiary company while providing attractive capital treatment are provided herein. In one embodiment, a method for creating an investment structure includes the steps of receiving investment capital from an investor in a subsidiary company; issuing convertible preferred shares from the subsidiary company to the investor; purchasing the target company by the subsidiary company with the investment capital; receiving at least one of target company common shares or target company assets in the subsidiary company; writing a first call option from the subsidiary company on the target company common shares or target company assets to the investor; and writing a second call option on the target company shares or target company assets from the investor to the parent company that at least partially owns the subsidiary company.

### CROSS-REFERENCE TO RELATED APPLICATIONS

This application claims the benefit of U.S. provisional patent application Ser. No. 60/642,282 filed Jan. 7, 2005, which is herein incorporated by reference.

### BACKGROUND OF THE INVENTION

1. Field of the Invention

The present invention is generally related to investment structures and, more particularly, to an investment structure that avoids ownership, earnings and capital ratio dilution to a parent company that is purchasing a target company through a subsidiary company using investment capital supplied by a third party investor.

2. Description of the Related Art

In deciding how to finance an acquisition, companies have several choices, each with different pros and cons. If an acquiring company funds an acquisition with new equity, it may dilute the ownership and share of earnings attributable to existing shareholders. If the company uses new debt, it increases leverage measured by the ratio of debt to equity and equity to assets. Some acquirers or their corporate parents—financial institutions, for instance—may have constraints regarding leverage. In such cases, an acquirer may be compelled to issue equity in order to maintain certain capital ratios. Issuing equity avoids the dilution of important capital ratios, however, as discussed above it comes at the cost of diluting the existing owners' stake in the business and share of earnings.

Therefore, there is a need in the art for an investment structure that minimizes ownership, earnings and capital ratio dilution simultaneously.

### SUMMARY OF THE INVENTION

The present invention is an investment structure that avoids the earnings and ownership dilution related to an acquisition by a subsidiary company when purchasing a target company while providing attractive capital treatment. The investment structure involves a parent company, a subsidiary company, a third party investor and a target company. Third party investors invest cash into the subsidiary company in return for contingent convertible preferred shares issued by the subsidiary company. Since these convertible preferred shares are contingent, they are not currently dilutive to the ownership of the parent company in the subsidiary company. Because the convertible preferred shares have equity-like attributes, they are generally treated as equity. For instance, if the parent is a bank, and the preferred shares have a thirty year term, they may qualify as Tier 1 capital, a regulatory definition of high-quality equity, of which a minimum ratio must be maintained against assets. The subsidiary company uses the cash that is provided by the investor to purchase a target company. The subsidiary company receives common shares or assets in exchange for the cash used to purchase the target company. The subsidiary company will then write a call option on the target company's shares to the third party investor. The investor then writes an option on the target company's shares to the parent company. These call options are exercisable at a future time at a strike price that is below the expected value of target company shares in the future. The investor's call has a strike price that is lower than the strike price of the parent company's call option. As such, it is quite likely both the investor and the parent will exercise their call options. This means there is a high likelihood of the investor receiving fixed return, which serves to entice the investor to participate in the transaction. The contingency and conversion price of the convertible preferred shares may or may not be attained. If both are attained, the investor may convert the preferred shares to common shares in the subsidiary. If both are not attained, the preferred shares remain outstanding until the end of their term or some subsequent change agreed to by the parties. Since the contingently convertible preferred shares are classified as equity, the new capital acts as equity in capital ratio calculations but without the ownership and earnings dilution of a common equity issuance.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of an investment structure in accordance with the present invention;

FIG. 2 depicts a flow diagram of a method for creating the investment structure of FIG. 1; and

FIG. 3 depicts a flow diagram of a method for unwinding the call options between the parties issued in the investment structure of FIG. 1.

FIG. 4 depicts a flow diagram of a method for unwinding the investors preferred share position in the subsidiary issued in the investment structure of FIG. 1.

### DETAILED DESCRIPTION

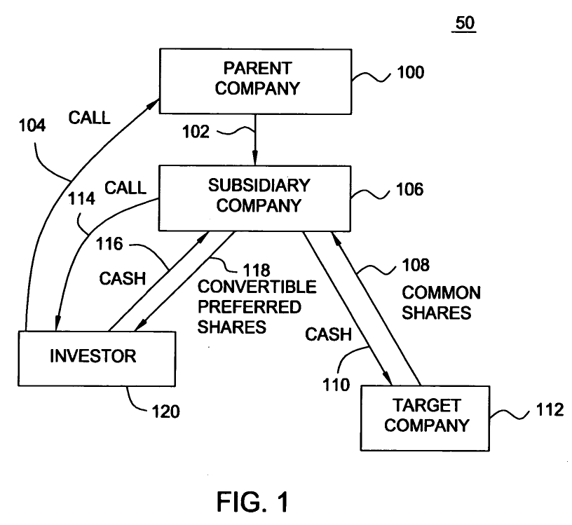

FIG. 1 depicts a block diagram of an investment structure 50 in accordance with the present invention. The structure 50 comprises four entities: a parent company 100, a subsidiary company 106 (or subsidiary 106), a target company 112 and an investor 120. The parent company 100 controls and consolidates the subsidiary company 106. The parent company 100 may be a bank or other financial institution that wholly or partially owns the subsidiary 106 that will be used to purchase the target company 112.

The investor 120 will invest cash (investment capital) along path 116 in return for contingent convertible preferred shares that are provided along path 118. The contingently convertible preferred issued to the investor 120 by the subsidiary 106 are consolidated into the capital ratio calculations of the parent company 100 and are counted as equity.

The subsidiary company 106 uses the cash received along path 116 from the investor 120 to purchase some or all of the common shares of the target company 112. The cash is exchanged along path 110 for common shares provided along path 108. As represented by path 114, the subsidiary company 106 then writes a call option on the target company's shares to the investor 120. The investor 120 writes a call option on the target company's shares to the parent company 100 along path 104.

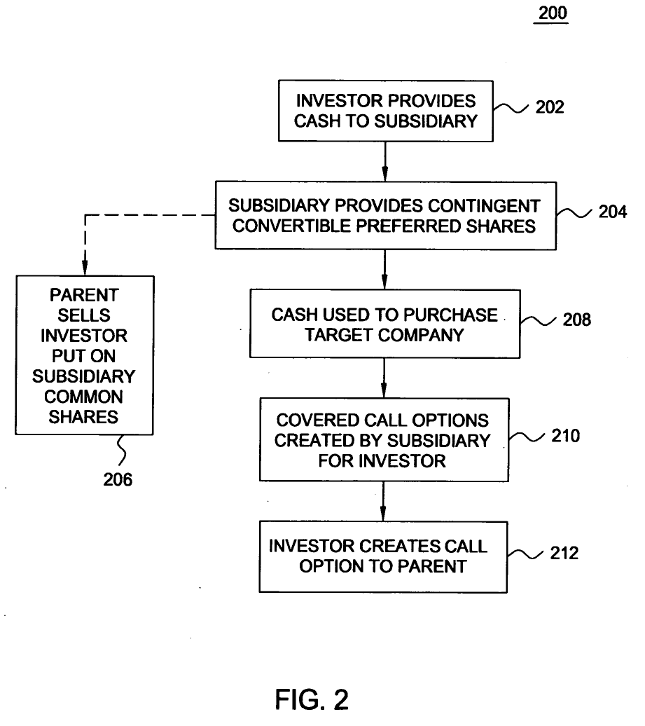

FIG. 2 depicts a flow diagram of a method 200 for establishing the investment structure of FIG. 1. At step 202, the investor 120 provides cash to the subsidiary 106. At step 204, the subsidiary 106 provides contingent convertible preferred shares to the investor 120. The preferred shares may or may not pay dividends, and the shares have a term that is predefined, e.g., 30 years. In addition to a fixed term, the preferred shares may be putable to the subsidiary 106 upon the parent company 100 spinning off or otherwise selling or liquidating the subsidiary company 106.

At step 208, the cash provided by the investor 120 to the subsidiary 106 is used to purchase the target company 112. At step 210, the subsidiary company 106 writes a covered call option against the target company's shares or assets and provides the option to the investor 120. At step 212, the investor 120 writes a call option for the target's shares to the parent company 100. If the parent company 100 still controls the subsidiary 106 at the time the parent company 100 elects to exercise its call on the target 112, the parent company 100 agrees to make the investor's preferred shares putable to the subsidiary 106.

In an alternative embodiment of the invention, the parent company 100 may additionally sell put options to the investor 120 on the common shares of the subsidiary company 106 to improve the attractiveness of the structure to an investor. The put options have a strike price that is substantially “out of the money”. This is indicated in method 200 as step 206.

Using the above-described investment structure 50, the subsidiary 106 retains all of the earnings of the target company 112. If the subsidiary 106 is consolidated into the parent company 100, the parent company 100 receives Tier 1 capital credit for the contingent convertible preferred shares issued to the investor 120.

The contingency on the convertible preferred shares is not necessarily based solely on time and a dollar value. Generally, the contingency may be based upon revenues of the subsidiary 106 or other financial indicators of the financial health of the subsidiary 106. If the contingency is not triggered, the preferred shares are not convertible even if the conversion price is reached.

The call option created by the subsidiary 106 for the investor 120 in the target company's common stock has a strike price that is much less than the expected value of the target company's common shares at some period in the future. The time in the future in which the option is exercisable can be set at any duration, but is typically set at five years. Typically, the call option written by the investor 120 to the parent company 100 has a higher strike price than the option to the investor 120. This arrangement of call options provides a vehicle to lock in a return for the investor 120. This enables the investor 120 to be provided sufficient return to entice investors to participate in such an investment structure.

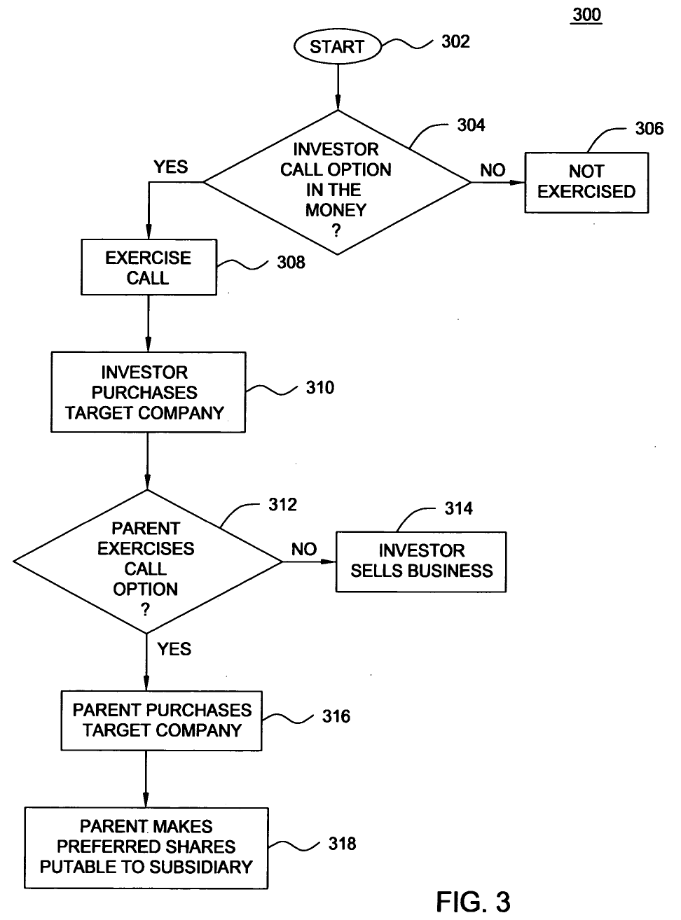

FIG. 3 depicts one embodiment of a method 300 of unwinding the investor 120 and/or parent company 100 of the call options in the investment structure 50. The method begins at step 302 and proceeds to step 304, where the investor's call option is analyzed to see if it is “in the money.” If the investor 120 deems the call option in the money, i.e., the price of the target company 112 exceeds the strike price of the option, the method 300 proceeds to step 308, wherein the call option will be exercised by the investor 120. If the investor's option is not in the money, the method 300 proceeds to step 306 and the call option is not exercised.

The target company 112 is purchased by the investor 120 at step 310. At step 312, the parent company 100 decides whether it will exercise its call option. In some circumstances, since the call option for the parent company 100 has a different strike price than the call option for the investor 120, the call option for the investor 120 may be in the money while the call option to the parent company 100 is out of the money. If the call option is to be exercised, the method 300 proceeds to step 316, where the common stock of the target company 112 is provided to the parent company 100 (i.e., the parent company 100 purchases the target company 112). At step 318, if the parent company 100 continues to control the subsidiary 106, the parent company 100 makes the preferred shares issued to the investor 120 immediately putable to the subsidiary. If, at step 312, the parent company 100 deems the call option unworthy of exercising, the method 300 proceeds to step 314 where the parent's call option expires unexcercised and the investor 120 is free to sell the target common shares to a third party.

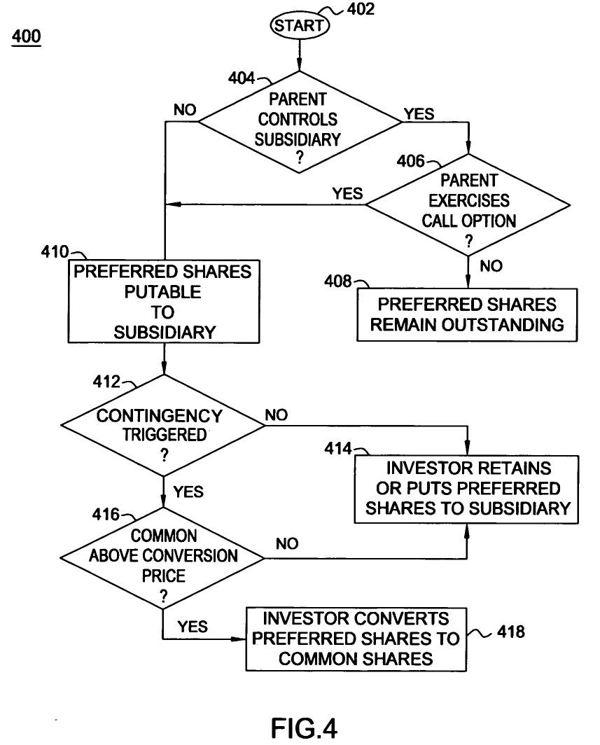

FIG. 4 depicts a flow diagram of a method 400 for extinguishing the preferred shares, if desired. The method 400 begins at step 402 and proceeds to step 404. At step 404, the method 400 queries whether the parent company 100 remains in control of the subsidiary company 106. If the parent company 100 has liquidated its position or otherwise sufficiently lessened control over the subsidiary company 106, the method 400 proceeds to step 410. At step 410, the subsidiary preferred shares become putable to the subsidiary 106 either because of a change in control or the parent's exercise of its call option to buy the target company 112 from the investor 120.

At step 412, the method 400 queries whether the contingency on the subsidiary preferred shares has occurred. If the contingency has been triggered, then the method 400 proceeds to step 416 to determine if the value of the shares is above the conversion price. If the preferred shares are valued above the conversion price, the method 400 proceeds to step 418, where the investor 120 converts the preferred shares to common shares of the subsidiary 106. Otherwise, the method 400 proceeds to step 414, where the investor 120 may retain the preferred shares or put the preferred shares.

If, at step 412, the contingency is not triggered, the preferred shares remain outstanding at step 414 where the investor 120 may retain the preferred shares or put the preferred shares.

If the parent company 100 controls the subsidiary 106, then at step 404, the method 400 proceeds to step 406, where the parent company 100 decides whether to exercise its call option. If exercised, the method 400 proceeds to step 410. If not exercised, the method 400 proceeds to step 408, where the preferred shares remain outstanding.

Separately, the investor 120 may exercise the put option purchased from the parent company 100 on the common stock of the subsidiary 106. It is generally envisioned that the put will be significantly out of the money at inception and would expire at the same time as the investor's call option on the target company 112.

Thus, by using the above-described investment structure 50, the parent company 100 can achieve several objectives in an attractive fashion: it can facilitate an important acquisition by a subsidiary 106 with no current and possibly no future ownership dilution, little to no earnings dilution and little to no reduction in key capital ratios reduction.

It is contemplated that the investment structure 50 described above may be used by other entities for similar transactions, i.e., any third-party funded investments in a target entity through a subsidiary of a parent entity. The parent company, subsidiary company, target company, and the investor may be any form of company, such as a corporation, partnership, sole proprietorship, and the like. In addition, although the terms “common stock” and “convertible preferred stock” are used above, the respective companies need not have formal shares of stock issued and may instead use contracts for a desired percentage ownership of the company having the same terms as desired for the particular portion of the transaction as detailed above. Furthermore, the investment capital need not be cash and may be any other asset having an agreed-upon value between the parties.

While the foregoing is directed to embodiments of the present invention, other and further embodiments of the invention may be devised without departing from the basic scope thereof, and the scope thereof is determined by the claims that follow.

1. A method for creating an investment structure that avoids earnings and ownership dilution for a parent company related to the acquisition of a target company, comprising:
receiving investment capital from an investor in a subsidiary company;
issuing convertible preferred shares from the subsidiary company to the investor;
purchasing the target company by the subsidiary company with the investment capital;
receiving at least one of target company common shares or target company assets in the subsidiary company;
writing a first call option from the subsidiary company on the target company common shares or target company assets to the investor; and
writing a second call option on the target company shares or target company assets from the investor to the parent company that at least partially owns the subsidiary company.

2. The method of claim 1, wherein the investment capital comprises cash.

3. The method of claim 1, wherein the convertible shares are contingent.

4. The method of claim 1, wherein the parent company comprises a bank.

5. The method of claim 1, wherein the second call option is exercisable at a future time at a second strike price that is below an expected value of target company shares at the future time.

6. The method of claim 5, wherein the first call option has a first strike price that is lower than the second strike price.

7. The method of claim 6, further comprising:
exercising the first and second call options;
achieving a contingency and conversion price for the convertible preferred shares; and
converting the preferred shares of the investor into common shares of the subsidiary.

8. The method of claim 7, further comprising leaving the preferred shares outstanding until the end of their respective terms if both the contingency and conversion price are not attained.

9. The method of claim 8, wherein the preferred shares comprise Tier I capital.

10. The method of claim 9, wherein the contingently convertible preferred shares are classified as equity, and new capital acts as equity in capital ratio calculations, without ownership and earnings dilution of a common equity issuance.

11. A method for a parent company to acquire a target company while avoiding ownership and earning dilution of a common equity issuance, comprising:
receiving a cash investment from an investor in a subsidiary company that is at least partially owned by the parent company;
issuing contingent convertible preferred shares representing the cash investment from the subsidiary company to the investor;
purchasing at least a portion of common shares in the target company by the subsidiary company with the cash investment;
writing a first covered call option from the subsidiary company on the target company's common shares to the investor; and
writing a second call option from the investor to the parent company on the target company's shares.

12. The method of claim 11, further comprising the parent company agreeing to make the investor's contingent convertible preferred shares putable to the subsidiary if, at the time the parent company elects to exercise the call on the target company, the parent has control of the subsidiary.

13. The method of claim 11, wherein the parent company comprises a bank.

14. The method of claim 11, wherein the second call option is exercisable at a future time at a second strike price that is below an expected value of target company shares at the future time.

15. The method of claim 11, wherein the first call option has a first strike price that is lower than the second strike price.

16. The method of claim 11, further comprising:
exercising the first and second call options;
achieving a contingency and conversion price for the convertible preferred shares; and
converting the preferred shares of the investor into common shares of the subsidiary.

17. The method of claim 11, further comprising unwinding the first and second call options, the unwinding comprising:
exercising the first covered call option if it is in the money so that the investor purchases the target company;
determining if the parent company exercises the second covered call option;
the investor selling the target company if the parent company does not exercise the second covered call option;
the parent company purchasing the target company if the parent company exercises the second covered call option; and
making the preferred shares putable to the subsidiary if the parent company exercises the second covered call option.

18. The method of claim 11, further comprising extinguishing the preferred shares, the method for extinguishing the preferred shares comprising:
determining if the parent company controls the subsidiary company;
exercising the second call option if the parent company is determined to own the subsidiary company;
making the preferred shares putable to the subsidiary company if the parent company is determined not to own the subsidiary;
determining if a conversion has been triggered by a contingency;
determining if the a value of the common shares is above a conversion price if the conversion has been triggered and converting the preferred shares to common shares; and
at least one of the investor retaining or putting the preferred shares if the conversion has not been triggered or if the value of the common shares is not above the conversion price.

19. A method for acquiring a target company that avoids earnings and ownership dilution related to the acquisition for a bank, comprising:
receiving liquid investment capital from an investor in a subsidiary company that is at least partially owned by the bank;
issuing contingent convertible preferred shares that qualify as Tier I capital from the subsidiary company to the investor;
purchasing the target company by the subsidiary company with the investment capital;
receiving at least one of target company common shares or target company assets in the subsidiary company;
writing a first call option having a first strike price from the subsidiary company on the target company common shares or company assets to the investor; and
writing a second call option having a second strike price on the target company shares from the investor to the bank, wherein the first strike price is lower than the second strike price and wherein the second strike price is below an expected value of target company shares at a future time.

20. The method of claim 19, further comprising:
exercising the first and second call options;
achieving a contingency and conversion price for the convertible preferred shares; and
converting the preferred shares of the investor into common shares of the subsidiary.

21. The method of claim 19, further comprising leaving the preferred shares outstanding until the end of their respective terms if both the contingency and conversion price are not attained.
